(19) United States
(12) Patent Application Publication
(10) Pub. No.: US 2024/0119798 A1
(43) Pub. Date: Apr. 11, 2024

(54) WAGERING GAMING SYSTEM WITH VARIABLE WIN-BOOST ELEMENT

(71) Applicant: SG Gaming, Inc., Las Vegas, NV (US)

(72) Inventors: Joshuah JACOB, Chicago, IL (US); Michael MASTROPIETRO, River Forest, IL (US)

(21) Appl. No.: 17/962,407

(22) Filed: Oct. 7, 2022

(51) Int. Cl. G07F 17/32

(52) U.S. Cl. CPC G07F 17/3267; G07F 17/3213; G07F 17/34

(57) ABSTRACT

Disclosed is a system and method of conducting a wagering game including displaying a plurality of symbols to indicate a randomly selected outcome of a wagering game in a display area and determining one or more award amounts for the randomly selected outcome. The one or more award amounts are based on the wager and the symbols of the randomly selected outcome. Upon the appearance of a variable “win-boost” symbol, which has no predetermined value, in the randomly selected outcome, the method further includes determining an initial amount based on the one or more award amounts, comparing the initial total award to a maximum award associated with the win-boost symbol and assigning the difference to the win-boost symbol. The initial total award and the difference are summed to create a final award equivalent to the maximum award.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2022, SG Gaming, Inc.

### FIELD OF THE INVENTION

The present invention relates to a technological improvement to gaming systems, gaming machines, and methods thereon and, more particularly, to new and improved wagering in connection with a game feature.

### BACKGROUND OF THE INVENTION

The gaming industry depends upon player participation. Players are generally “hopeful” players who either think they are lucky or at least think they can get lucky—for a relatively small investment to play a game, they can get a disproportionately large return. To create this feeling of luck, a gaming apparatus relies upon an internal or external random element generator to generate one or more random elements such as random numbers. The gaming apparatus determines a game outcome based, at least in part, on the one or more random elements.

A significant technical challenge is to improve the operation of gaming apparatus and games played thereon, including the manner in which they leverage the underlying random element generator, by making them yield a negative return on investment in the long run (via a high quantity and/or frequency of player/apparatus interactions) and yet random and volatile enough to make players feel they can get lucky and win in the short run. Striking the right balance between yield versus randomness and volatility to create a feeling of luck involves addressing many technical problems, some of which can be at odds with one another. This luck factor is what appeals to core players and encourages prolonged and frequent player participation. As the industry matures, the creativity and ingenuity required to improve such operation of gaming apparatus and games grows accordingly.

Another significant technical challenge is to improve the operation of gaming apparatus and games played thereon by increasing processing speed and efficiency of usage of processing and/or memory resources. To make games more entertaining and exciting, they often offer the complexities of advanced graphics and special effects, multiple bonus features with different game formats, and multiple random outcome determinations per feature. The game formats may, for example, include picking games, reel spins, wheel spins, and other arcade-style play mechanics. Inefficiencies in processor execution of the game software can slow play of the game and prevent a player from playing the game at their desired pace.

Yet another significant technical challenge is to provide a new and improved level of game play that uses new and improved gaming apparatus animations. Improved animations represent improvements to the underlying technology or technical field of gaming apparatus and, at the same time, have the effect of encouraging prolonged and frequent player participation.

Additionally, regulations and legal requirements for gaming apparatus may limit the amount of a payout for an instance of play on a gaming apparatus. For example, in certain jurisdictions, if any single win or combination of wins is over a jurisdictional payout limit, then the gaming apparatus is prohibited from awarding anything above the maximum allowed by law to the player. In these jurisdictions, the remaining overpay amount may be thrown out at the player's expense or deferred in some way. A significant technical challenge is to avoid overpayments while still offering the opportunity for attractive high-paying awards. Such improvements serve to reduce overall software and game rule complexity and to reduce the processing power, data storage, and network bandwidth requirements related to overpay handling.

### SUMMARY OF THE INVENTION

Disclosed are a system and method of conducting a wagering game including displaying a plurality of symbols to indicate a randomly selected outcome of a wagering game in a display area and determining one or more award amounts for the randomly selected outcome.

The one or more award amounts are based on the wager and the symbols of the randomly selected outcome. Upon the appearance of a variable “win-boost” symbol, which has no singular predetermined value, in the randomly selected outcome, the method further includes determining an initial total award based on the one or more award amounts, comparing the initial total award to a maximum award associated with the win-boost symbol and assigning the difference to the win-boost symbol. The initial total award and the difference are summed to create a final award equivalent to the maximum award.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a perspective view of a free-standing gaming machine according to an embodiment of the present invention.

FIG. 2 is a schematic view of a gaming system according to an embodiment of the present invention.

FIG. 3 is a flowchart for a data processing method that corresponds to instructions executed by a controller, according to an embodiment of the present invention.

FIGS. 4-7 illustrate examples of a game presentations in accordance with one or more embodiments.

FIGS. 8A and 8B illustrate examples of award meters in accordance with one or more embodiments.

FIG. 9 illustrates an example of a pay table in accordance with one or more embodiments.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

For purposes of the present detailed description, the terms “wagering game,” “casino wagering game,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game involves wagers of real money, as found with typical land-based or online casino games. In other embodiments, the wagering game additionally, or alternatively, involves wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

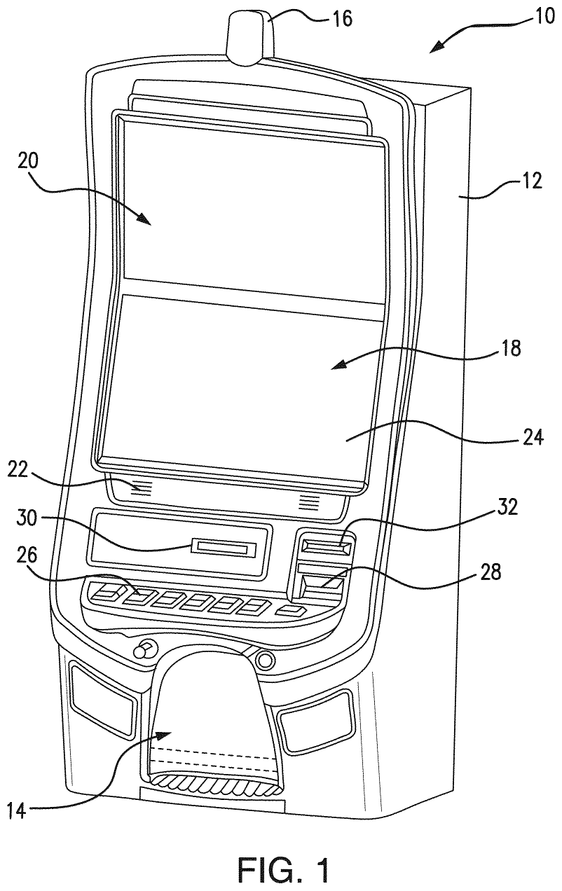

Referring to FIG. 1, there is shown a gaming machine 10 similar to those operated in gaming establishments, such as casinos. With regard to the present invention, the gaming machine 10 may be any type of gaming terminal or machine and may have varying structures and methods of operation. For example, in some aspects, the gaming machine 10 is an electromechanical gaming terminal configured to play mechanical slots, whereas in other aspects, the gaming machine is an electronic gaming terminal configured to play a video casino game, such as slots, keno, poker, blackjack, roulette, craps, etc. The gaming machine 10 may take any suitable form, such as floor-standing models as shown, handheld mobile units, bartop models, workstation-type console models, etc. Further, the gaming machine 10 may be primarily dedicated for use in playing wagering games, or may include non-dedicated devices, such as mobile phones, personal digital assistants, personal computers, etc. Exemplary types of gaming machines are disclosed in U.S. Pat. Nos. 6,517,433, 8,057,303, and 8,226,459, which are incorporated herein by reference in their entireties.

The gaming machine 10 illustrated in FIG. 1 comprises a gaming cabinet 12 that securely houses various input devices, output devices, input/output devices, internal electronic/electromechanical components, and wiring. The cabinet 12 includes exterior walls, interior walls, and shelves for mounting the internal components and managing the wiring, and one or more front doors that are locked and require a physical or electronic key to gain access to the interior compartment of the cabinet 12 behind the locked door. The cabinet 12 forms an alcove 14 configured to store one or more beverages or personal items of a player. A notification mechanism 16, such as a candle or tower light, is mounted to the top of the cabinet 12. It flashes to alert an attendant that change is needed, a hand pay is requested, or there is a potential problem with the gaming machine 10.

The input devices, output devices, and input/output devices are disposed on, and securely coupled to, the cabinet 12. By way of example, the output devices include a primary presentation device 18, a secondary presentation device 20, and one or more audio speakers 22. The primary presentation device 18 or the secondary presentation device 20 may be a mechanical-reel display device, a video display device, or a combination thereof. In one such combination disclosed in U.S. Pat. No. 6,517,433, a transmissive video display is disposed in front of the mechanical reel display to portray a video image superimposed upon electro-mechanical reels. In another combination disclosed in U.S. Pat. No. 7,654,899, a projector projects video images onto stationary or moving surfaces. In yet another combination disclosed in U.S. Pat. No. 7,452,276, miniature video displays are mounted to electro-mechanical reels and portray video symbols for the game. In a further combination disclosed in U.S. Pat. No. 8,591,330, flexible displays such as OLED or e-paper displays are affixed to electro-mechanical reels. The aforementioned U.S. Pat. Nos. 6,517,433, 7,654,899, 7,452,276, and 8,591,330 are incorporated herein by reference in their entireties.

The presentation devices 18, 20, the audio speakers 22, lighting assemblies, and/or other devices associated with presentation are collectively referred to as a “presentation assembly” of the gaming machine 10. The presentation assembly may include one presentation device (e.g., the primary presentation device 18), some of the presentation devices of the gaming machine 10, or all of the presentation devices of the gaming machine 10. The presentation assembly may be configured to present a unified presentation sequence formed by visual, audio, tactile, and/or other suitable presentation means, or the devices of the presentation assembly may be configured to present respective presentation sequences or respective information.

The presentation assembly, and more particularly the primary presentation device 18 and/or the secondary presentation device 20, variously presents information associated with wagering games, non-wagering games, community games, progressives, advertisements, services, premium entertainment, text messaging, emails, alerts, announcements, broadcast information, subscription information, etc. appropriate to the particular mode(s) of operation of the gaming machine 10. The gaming machine 10 may include a touch screen(s) 24 mounted over the primary or secondary presentation devices, buttons 26 on a button panel, a bill/ticket acceptor 28, a card reader/writer 30, a ticket dispenser 32, and player-accessible ports (e.g., audio output jack for headphones, video headset jack, USB port, wireless transmitter/receiver, etc.). It should be understood that numerous other peripheral devices and other elements exist and are readily utilizable in any number of combinations to create various forms of a gaming machine in accord with the present concepts.

The player input devices, such as the touch screen 24, buttons 26, a mouse, a joystick, a gesture-sensing device, a voice-recognition device, and a virtual-input device, accept player inputs and transform the player inputs to electronic data signals indicative of the player inputs, which correspond to an enabled feature for such inputs at a time of activation (e.g., pressing a “Max Bet” button or soft key to indicate a player's desire to place a maximum wager to play the wagering game). The inputs, once transformed into electronic data signals, are output to game-logic circuitry for processing. The electronic data signals are selected from a group consisting essentially of an electrical current, an electrical voltage, an electrical charge, an optical signal, an optical element, a magnetic signal, and a magnetic element.

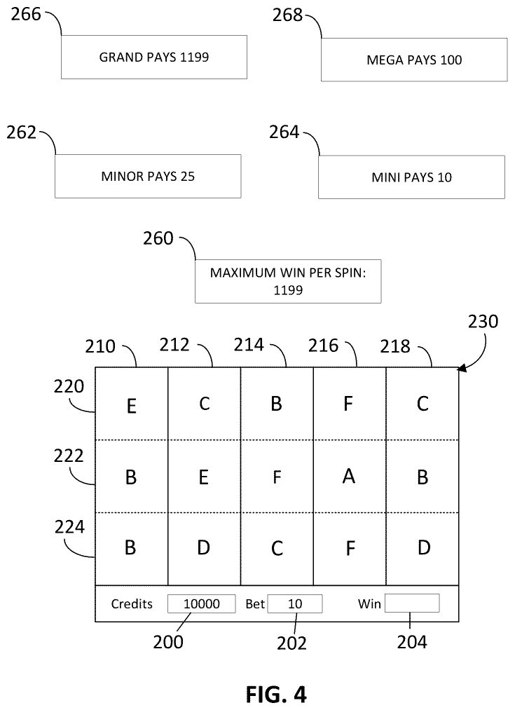

The gaming machine 10 includes one or more value input/payment devices and value output/payout devices. In order to deposit cash or credits onto the gaming machine 10, the value input devices are configured to detect a physical item associated with a monetary value that establishes a credit balance on a credit meter such as the “credits” meter 200 (see FIG. 4). The physical item may, for example, be currency bills, coins, tickets, vouchers, coupons, cards, and/or computer-readable storage mediums. The deposited cash or credits are used to fund wagers placed on the wagering game played via the gaming machine 10. Examples of value input devices include, but are not limited to, a coin acceptor, the bill/ticket acceptor 28, the card reader/writer 30, a wireless communication interface for reading cash or credit data from a nearby mobile device, and a network interface for withdrawing cash or credits from a remote account via an electronic funds transfer. In response to a cashout input that initiates a payout from the credit balance on the “credits” meter 200 (see FIG. 4), the value output devices are used to dispense cash or credits from the gaming machine 10. The credits may be exchanged for cash at, for example, a cashier or redemption station. Examples of value output devices include, but are not limited to, a coin hopper for dispensing coins or tokens, a bill dispenser, the card reader/writer 30, the ticket dispenser 32 for printing tickets redeemable for cash or credits, a wireless communication interface for transmitting cash or credit data to a nearby mobile device, and a network interface for depositing cash or credits to a remote account via an electronic funds transfer.

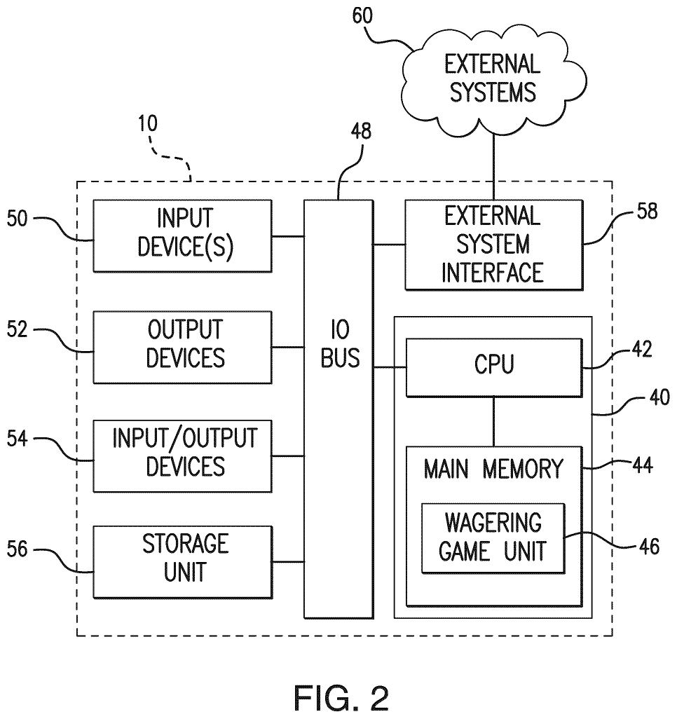

Turning now to FIG. 2, there is shown a block diagram of the gaming-machine architecture. The gaming machine 10 includes game-logic circuitry 40 securely housed within a locked box inside the gaming cabinet 12 (see FIG. 1). The game-logic circuitry 40 includes a central processing unit (CPU) 42 connected to a main memory 44 that comprises one or more memory devices. The CPU 42 includes any suitable processor(s), such as those made by Intel and AMD. By way of example, the CPU 42 includes a plurality of microprocessors including a master processor, a slave processor, and a secondary or parallel processor. Game-logic circuitry 40, as used herein, comprises any combination of hardware, software, or firmware disposed in or outside of the gaming machine 10 that is configured to communicate with or control the transfer of data between the gaming machine 10 and a bus, another computer, processor, device, service, or network. The game-logic circuitry 40, and more specifically the CPU 42, comprises one or more controllers or processors and such one or more controllers or processors need not be disposed proximal to one another and may be located in different devices or in different locations. The game-logic circuitry 40, and more specifically the main memory 44, comprises one or more memory devices which need not be disposed proximal to one another and may be located in different devices or in different locations. The game-logic circuitry 40 is operable to execute all of the various gaming methods and other processes disclosed herein. The main memory 44 includes a wagering-game unit 46. In one embodiment, the wagering-game unit 46 causes wagering games to be presented, such as video poker, video blackjack, video slots, video lottery, etc., in whole or part.

The game-logic circuitry 40 is also connected to an input/output (I/O) bus 48, which can include any suitable bus technologies, such as an AGTL+ frontside bus and a PCI backside bus. The I/O bus 48 is connected to various input devices 50, output devices 52, and input/output devices 54 such as those discussed above in connection with FIG. 1. The I/O bus 48 is also connected to a storage unit 56 and an external-system interface 58, which is connected to external system(s) 60 (e.g., wagering-game networks).

The external system 60 includes, in various aspects, a gaming network, other gaming machines or terminals, a gaming server, a remote controller, communications hardware, or a variety of other interfaced systems or components, in any combination. In yet other aspects, the external system 60 comprises a player's portable electronic device (e.g., cellular phone, electronic wallet, etc.) and the external-system interface 58 is configured to facilitate wireless communication and data transfer between the portable electronic device and the gaming machine 10, such as by a near-field communication path operating via magnetic-field induction or a frequency-hopping spread spectrum RF signals (e.g., Bluetooth, etc.).

The gaming machine 10 optionally communicates with the external system 60 such that the gaming machine 10 operates as a thin, thick, or intermediate client. The game-logic circuitry 40—whether located within (“thick client”), external to (“thin client”), or distributed both within and external to (“intermediate client”) the gaming machine 10—is utilized to provide a wagering game on the gaming machine 10. In general, the main memory 44 stores programming for a random number generator (RNG), game-outcome logic, and game assets (e.g., art, sound, etc.)—all of which obtained regulatory approval from a gaming control board or commission and are verified by a trusted authentication program in the main memory 44 prior to game execution. The authentication program generates a live authentication code (e.g., digital signature or hash) from the memory contents and compare it to a trusted code stored in the main memory 44. If the codes match, authentication is deemed a success and the game is permitted to execute. If, however, the codes do not match, authentication is deemed a failure that must be corrected prior to game execution. Without this predictable and repeatable authentication, the gaming machine 10, external system 60, or both are not allowed to perform or execute the RNG programming or game-outcome logic in a regulatory-approved manner and are therefore unacceptable for commercial use. In other words, through the use of the authentication program, the game-logic circuitry facilitates operation of the game in a way that a person making calculations or computations could not.

When a wagering-game instance is executed, the CPU 42 (comprising one or more processors or controllers) executes the RNG programming to generate one or more pseudo-random numbers. The pseudo-random numbers are divided into different ranges, and each range is associated with a respective game outcome. Accordingly, the pseudo-random numbers are utilized by the CPU 42 when executing the game-outcome logic to determine a resultant outcome for that instance of the wagering game. The resultant outcome is then presented to a player of the gaming machine 10 by accessing the associated game assets, required for the resultant outcome, from the main memory 44. The CPU 42 causes the game assets to be presented to the player as outputs from the gaming machine 10 (e.g., audio and video presentations). Instead of a pseudo-RNG, the game outcome may be derived from random numbers generated by a physical RNG that measures some physical phenomenon that is expected to be random and then compensates for possible biases in the measurement process. Whether the RNG is a pseudo-RNG or physical RNG, the RNG uses a seeding process that relies upon an unpredictable factor (e.g., human interaction of turning a key) and cycles continuously in the background between games and during game play at a speed that cannot be timed by the player. Accordingly, the RNG cannot be carried out manually by a human and is integral to operating the game.

The gaming machine 10 may be used to play central determination games, such as electronic pull-tab and bingo games. In an electronic pull-tab game, the RNG is used to randomize the distribution of outcomes in a pool and/or to select which outcome is drawn from the pool of outcomes when the player requests to play the game. In an electronic bingo game, the RNG is used to randomly draw numbers that players match against numbers printed on their electronic bingo card.

The gaming machine 10 may include additional peripheral devices or more than one of each component shown in FIG. 2. Any component of the gaming-machine architecture includes hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic-disk storage media, optical storage media, flash memory, etc.

In accordance with various methods of conducting a wagering game on a gaming system in accord with the present concepts, the wagering game includes a game sequence in which a player makes a wager, and a wagering-game outcome is provided or displayed in response to the wager being received or detected. The wagering-game outcome, for that particular wagering-game instance, is then revealed to the player in due course following initiation of the wagering game. The method comprises the acts of conducting the wagering game using a gaming apparatus, such as the gaming machine 10 depicted in FIG. 1, following receipt of an input from the player to initiate a wagering-game instance. The gaming machine 10 then communicates the wagering-game outcome to the player via one or more output devices (e.g., primary presentation device 18 or secondary presentation device 20) through the presentation of information such as, but not limited to, text, graphics, static images, moving images, etc., or any combination thereof. In accord with the method of conducting the wagering game, the game-logic circuitry 40 transforms a physical player input, such as a player's pressing of a “Spin” touch key or button, into an electronic data signal indicative of an instruction relating to the wagering game (e.g., an electronic data signal bearing data on a wager amount).

In the aforementioned method, for each data signal, the game-logic circuitry 40 is configured to process the electronic data signal, to interpret the data signal (e.g., data signals corresponding to a wager input), and to cause further actions associated with the interpretation of the signal in accord with stored instructions relating to such further actions executed by the controller. As one example, the CPU 42 causes the recording of a digital representation of the wager in one or more storage media (e.g., storage unit 56), the CPU 42, in accord with associated stored instructions, causes the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM, etc.). The noted second state of the data storage media comprises storage in the storage media of data representing the electronic data signal from the CPU 42 (e.g., the wager in the present example). As another example, the CPU 42 further, in accord with the execution of the stored instructions relating to the wagering game, causes the primary presentation device 18, other presentation device, or other output device (e.g., speakers, lights, communication device, etc.) to change from a first state to at least a second state, wherein the second state of the primary presentation device comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of the stored instructions relating to the wagering game is further conducted in accord with a random outcome (e.g., determined by the RNG) that is used by the game-logic circuitry 40 to determine the outcome of the wagering-game instance. In at least some aspects, the game-logic circuitry 40 is configured to determine an outcome of the wagering-game instance at least partially in response to the random parameter.

In one embodiment, the gaming machine 10 and, additionally or alternatively, the external system 60 (e.g., a gaming server), means gaming equipment that meets the hardware and software requirements for fairness, security, and predictability as established by at least one state's gaming control board or commission. Prior to commercial deployment, the gaming machine 10, the external system 60, or both and the casino wagering game played thereon may need to satisfy minimum technical standards and require regulatory approval from a gaming control board or commission (e.g., the Nevada Gaming Commission, Alderney Gambling Control Commission, National Indian Gaming Commission, etc.) charged with regulating casino and other types of gaming in a defined geographical area, such as a state. By way of non-limiting example, a gaming machine in Nevada means a device as set forth in NRS 463.0155, 463.0191, and all other relevant provisions of the Nevada Gaming Control Act, and the gaming machine cannot be deployed for play in Nevada unless it meets the minimum standards set forth in, for example, Technical Standards 1 and 2 and Regulations 5 and 14 issued pursuant to the Nevada Gaming Control Act. Additionally, the gaming machine and the casino wagering game must be approved by the commission pursuant to various provisions in Regulation 14. Comparable statutes, regulations, and technical standards exist in or are used in other gaming jurisdictions, including for example GLI Standard #11 of Gaming Laboratories International (which defines a gaming device in Section 1.5) and N.J.S.A 5:12-23, 5:12-45, and all other relevant provisions of the New Jersey Casino Control Act. As can be seen from the description herein, the gaming machine 10 may be regulatorily approved and thus implemented with hardware and software architectures, circuitry, and other special features that differentiate it from general-purpose computers (e.g., desktop PCs, laptops, and tablets).

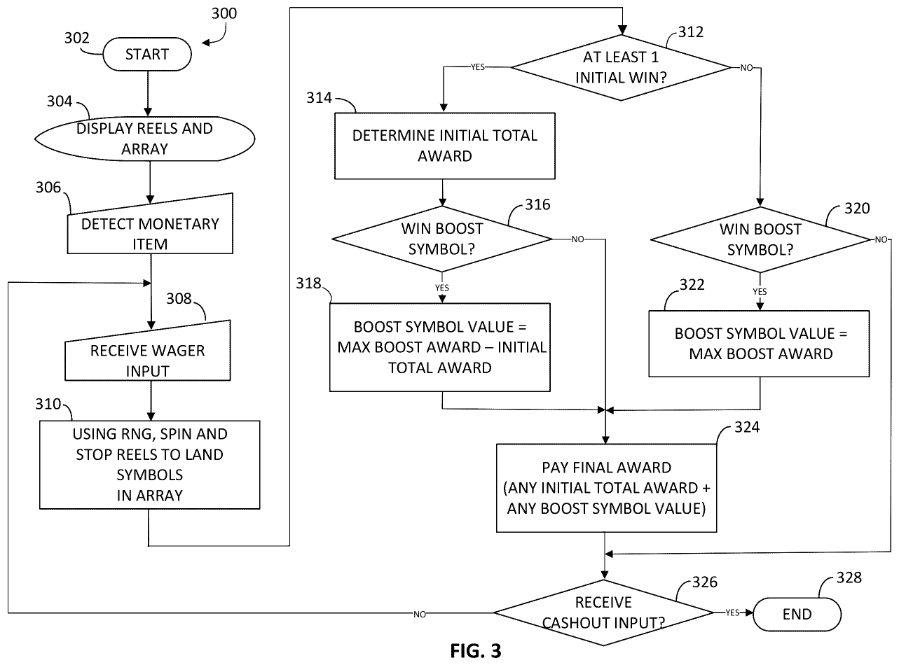

Referring now to FIGS. 3-9, a wagering game with a variable win-boost element will be described. In such wagering games, when a player achieves an outcome including a variable win-boost symbol, a supplemental award equal to the difference between a maximum award associated with the win-boost symbol and the sum of all other outcome award amounts achieved from the outcome of the wagering game is assigned to the win-boost bonus symbol. The maximum award is a fixed and predetermined number of credits or currency for all plays of the wagering game. Accordingly, when a player achieves an outcome of the wagering game that provides an aggregate award amount that is less than the maximum award and the outcome also includes the win-boost symbol, the player advantageously receives a supplemental award amount that increases the payout to the maximum award for the outcome of the wagering game.

Referring now to FIG. 3, there is shown a flowchart representing one data processing method 300 corresponding to at least some instructions stored and executed by the game-logic circuitry 40 in FIG. 2 to perform operations according to an embodiment of the present invention. The data processing method 300 is described below in connection with an exemplary representation of a set of game presentations in FIGS. 4-7.

The data processing method commences at step 302. At step 304, the game-logic circuitry controls one or more presentation devices (e.g., mechanical-reel display device, video display device, or a combination thereof) that presents a plurality of symbol-bearing reels and an array of symbol positions. Although the method is described with respect to one presentation device, it is to be understood that the presentation described herein may be performed by a presentation assembly including more than one presentation device. The symbol positions of the array may be arranged in a variety of configurations, formats, or structures and may comprise a plurality of rows and columns. The rows of the array are oriented in a generally horizontal direction, and the columns of the array are oriented in a generally vertical direction. The symbol positions in each row of the array are horizontally aligned with each other, and the symbol positions in each column of the array are vertically aligned with each other. The number of symbol positions in different rows and/or different columns may vary from each other. The reels may be associated with the respective columns of the array such that the reels spin vertically, and each reel populates a respective column. In another embodiment, the reels may be associated with the respective rows of the array such that the reels spin horizontally, and each reel populates a respective row. In yet another embodiment, the reels may be associated with respective individual symbol positions of the array such that each reel populates only its respective symbol position.

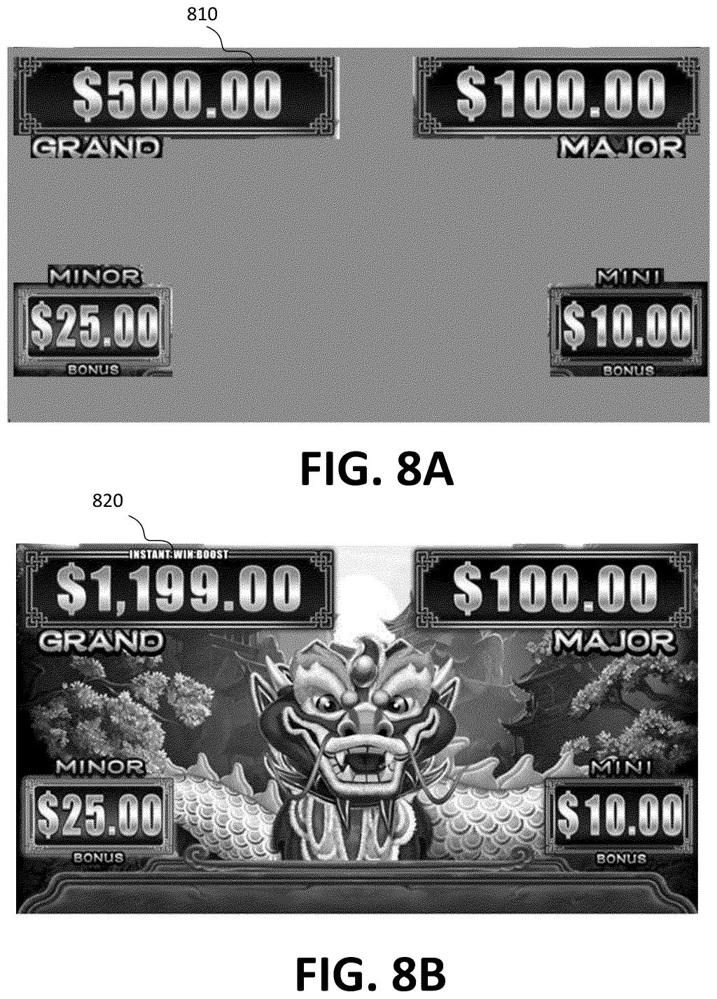

In the examples shown in FIGS. 4-7, the presentation device presents a three-by-five array 230 comprising three rows 220, 222, 224 and five columns 210, 212, 214, 216, 218. Each column is associated with a respective reel such that the reel populates the three symbol positions in the associated column. The reels bear a plurality of symbols. In one embodiment, the plurality of symbols include standard symbols A, B, C, D, E, and F and value-bearing symbols, otherwise known as WYSIWYG (“What You See is What You Get”) or “cash on reels” symbols. Each value-bearing symbol is associated with a credit or currency value indicated on the symbol itself. The value on a particular credit-bearing symbol may be fixed or variable (e.g., random) from one game cycle to the next. Different value-bearing symbols on the reels may have different values. In one or more embodiments, a value-bearing symbol may be associated with a value determined or displayed separately (FIGS. 8A-B). For example, rather than a specific amount, a GRAND, MAJOR, MINOR, or MINI award label may be indicated on a value-bearing symbol. Each reel may contain one or more stacks (i.e., clumps) of value-bearing symbols that appear adjacent to each other along the reel. The values of the value-bearing symbols in any given stack may be the same or different. A stack of value-bearing symbols may consist of two, three, four, or more adjacent symbols. Further, adjacent reels may contain one or more “mega” value-bearing symbols that move as one block as the reels spin. When the spin is complete, each individual row and column of the array underlying any visible portion of the “mega” symbol is assigned the value associated with the “mega” value-bearing symbol. For example, a “mega” value bearing symbol may comprise two-row high square spanning columns 212 and 214. If this symbol stops aligned with rows 220 and 222, the symbols at row 220, column 212, row 220, column 214, row 222, column 212 and row 222, column 214 would all be treated as though individual value-bearing symbols having the value of the “mega” symbol had landed in those locations.

Returning to FIG. 3, at step 306, the game-logic circuitry detects, via a value input device, a physical item associated with a monetary value that establishes a credit balance. As shown in FIG. 4, the credit balance may be shown on a credit meter 200 of the gaming machine.

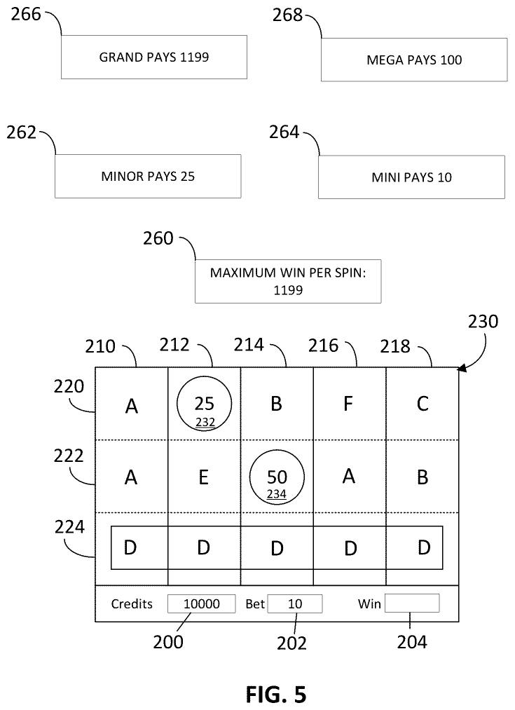

At step 308, the game-logic circuitry initiates a wagering-game cycle in response to an input indicative of a wager covered by the credit balance. To initiate a spin of the reels, the player may press a wager key selected from a first set of base game wagers 510 displayed on a bet panel 500 (FIG. 5A). As shown in FIG. 4, the selected wager may be shown on a bet meter 202.

At step 310, using an RNG, the game-logic circuitry spins and stops the reels to randomly land symbols from the reels in the array, which may be in visual association with one or more pay lines or other pay arrangements. The reel spin may be animated on a video display by depicting symbol-bearing strips moving vertically across the display and synchronously updating the symbols visible on each strip as the strip moves across the display.

At step 312, the randomly selected outcome is evaluated via the game-logic circuitry to determine whether the randomly selected outcome includes at least one winning outcome. If it is determined, at step 312, that the randomly selected outcome does not include at least one winning outcome, then the method proceeds to step 320, described below.

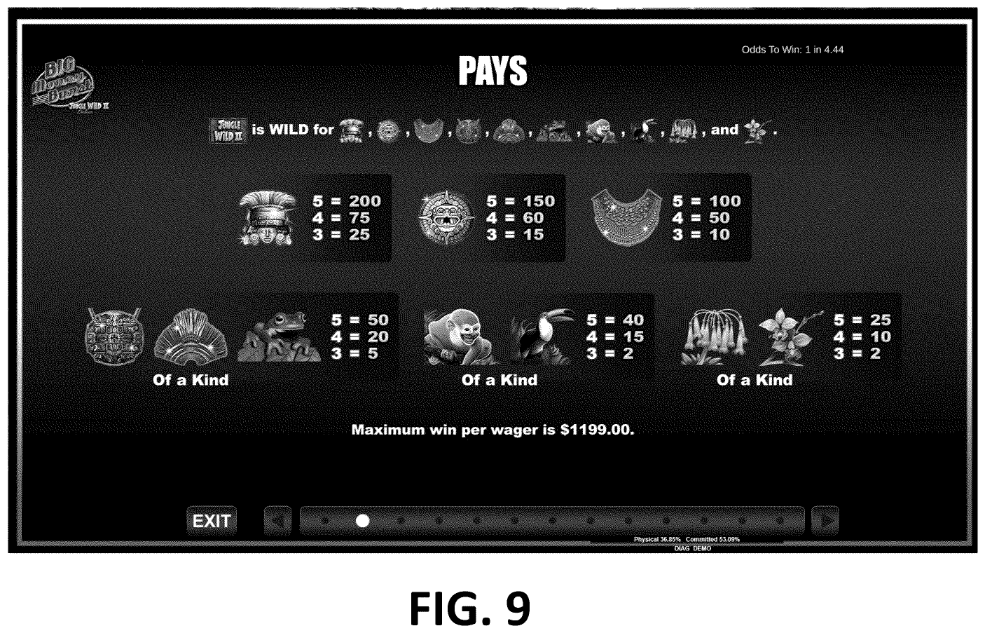

If it is determined, at step 312 that the randomly selected outcome includes at least one winning outcome, the game logic circuitry determines pays for winning combinations of symbols in accordance with a pay table at step 314. An example paytable may be found in FIG. 9, with the understanding that the various symbols icons generally equate to the exemplary A, B, C, D, E, and F symbols described above with respect to FIGS. 4-7. The base game pay table, for example and without limitation, may include “line pays,” “scatter pays,” “ways pays,” or combinations thereof. Line pays occur when a predetermined type and number of symbols appear along an activated payline, typically in a particular order such as left to right, right to left, top to bottom, bottom to top, etc. Scatter pays occur when a predetermined type and number of symbols appear anywhere in the displayed array without regard to position or paylines. “Ways pays” occur when like symbols in winning combinations appear on adjacent reels without the requirement to be on a specified pay line or directly adjacent to one another. For example, a three by five symbol array has 243 (3⁵) ways to win. In a 243 ways slot machine, any combination of three or more matching symbols can be a win, provided they appear anywhere on adjacent reels, starting from the first reel and going left to right. Only one instance of a symbol on a reel is included in a winning combination. Thus, the best combination is a five of a kind. The non-limiting examples of FIGS. 4-7 assume a pay table based on line pays. Each payline preferably consists of a single symbol position in each column of the array. The number of paylines may be as few as one or as many as possible given each payline consists of a single symbol position in each column of the array. In FIGS. 4-7, standard pays are limited to line pays along three horizontal paylines starting from the leftmost reel: a first payline spanning the middle row 224 of the array 230, a second payline spanning the top row 222 of the array 230, and a third payline spanning the bottom row 226 of the array 230. Standard pays may also be supplemented by values borne by value-bearing symbols, as described above. Any determined awards are summed at step 314 to determine an initial total award.

At step 316, the presence of any win-boost symbol in the array is detected. If a win-boost symbol is detected at step 316, any difference between the maximum award and the initial total award is assigned to the win-boost symbol at step 318.

If, however, the randomly selected outcome does not include at least one winning outcome at step 312, the presence of any win-boost symbol in the array is detected at step 320. If no win-boost symbol is detected at step 320, no award is due the player and the method proceeds directly to step 326. If a win-boost symbol is detected at step 320, the full maximum award is assigned to the win-boost symbol at step 322. The method then continues, from either step 318 or step 322, to step 324, where any determined win-boost symbol value (step 318 or step 322) is added to any initial total award (step 314) to create a final award. If no win-boost symbol was detected at step 316 or step 320, the final award will simply be equal to the initial total award. Otherwise, if a win-boost symbol was detected, at step 316 or step 320, the final award will equal the maximum award.

The final award is paid to the player at step 324 and reflected in the win meter 204. To animate a pay, the display may apply a border, pattern, color change, background change, watermark, or other distinguishing characteristic to the winning payline and/or winning symbols that contributed to the pay. This completes a spin cycle of the game (steps 308-324).

At step 326, the player may then enter a cashout input, which terminates the method at step 328, or another spin cycle may be initiated with a new wager at step 308.

FIGS. 4-7 illustrate non-limiting examples of wagering game screens 230, each displaying a randomly selected outcome for a spin cycle of a wagering game employing a win-boost element. In the exemplary wagering game illustrated in FIGS. 4-7, the maximum award that may be won as the result of a single game outcome is 1199 credits, reflected in the announcement indicator 260.

In the description of each of FIGS. 4-7 below, reference is made to certain applicable steps from FIG. 3.

Referring to FIG. 4, which illustrates an example of the display at the conclusion of a first representative base-game spin (steps 308-310):
No winning combinations of symbols are detected at step 312, thus the method proceeds directly to step 320 to see if the array contains a win-boost symbol. Since the array does not contain a win-boost symbol, no award is due the player and the method continues to step 326 to determine if the player wishes to play another game.

Referring to FIG. 5, which illustrates an example of the display at the conclusion of a second representative base game spin (steps 308-310):
The appearance of five D symbols in row 224 (step 310) is detected at step 312.
Two value-bearing symbols 232 and 234 also appeared in columns 212 and 214 (step 310).
A credit award for the five D symbols, for example, 100 credits, is derived from the pay table, and the values borne by the value-bearing symbols 232 and 234 are also summed to determine an initial total award of 175 credits (100+25+50) at step 314.
No bonus win-boost symbol appears in the array at step 316, so the initial total award is not boosted at step 318. The final award is set to 175 credits and paid at step 324.

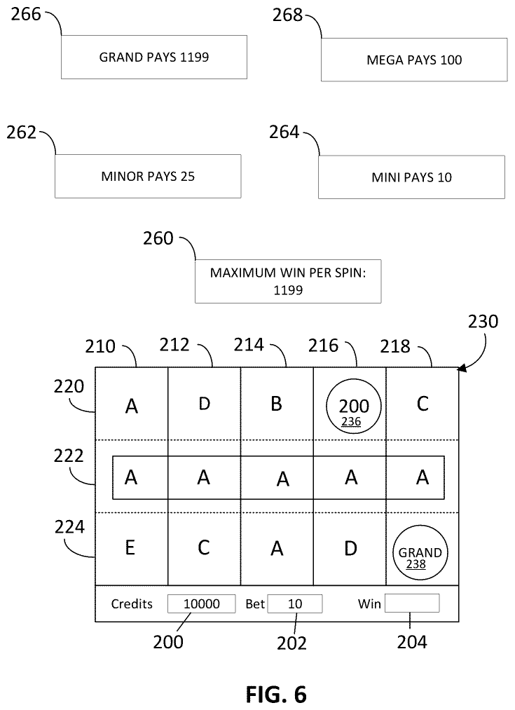

Referring to FIG. 6, which illustrates an example of the display at the conclusion of a third representative base game spin (steps 308-310):
The appearance of four A symbols in row 222 (step 310) is detected at step 312.
One value-bearing symbol 236 landed also in column 216 (step 310).
A credit award for the four A symbols, for example, 40 credits, is derived from the pay table and the value borne by the value-bearing symbol 236 (200 credits) is summed to determine an initial total award of 240 credits (200+40) at step 314.
A GRAND bonus win-boost symbol 238 appears in the array in row 224 and is detected at step 316. The initial total award total of 240 credits is subtracted from the maximum win-boost amount, in this case 1199 credits, to determine a boost award of 959 credits (step 318), the value of which is assigned to the win-boost symbol.
The 959-credit boost award is added to the 240-credit initial total award to establish a final award of 1199 credits, which is paid at step 324.

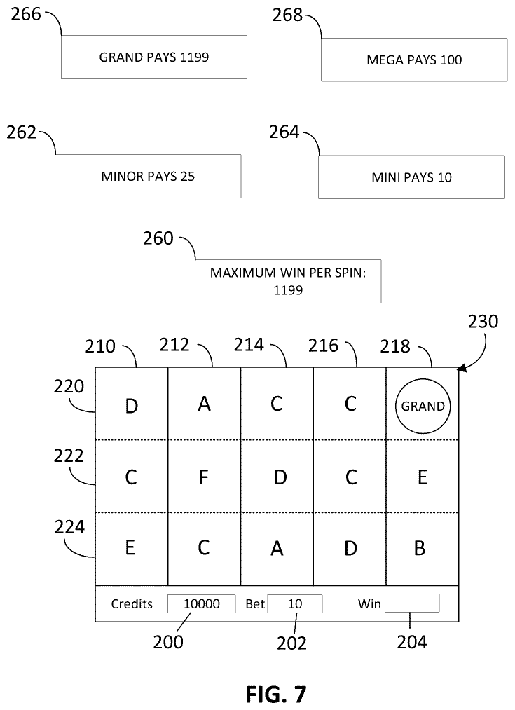

Referring to FIG. 7, which illustrates an example of the display at the conclusion of a fourth representative base game spin (steps 308-310):
No basic winning combinations of symbols are detected in the array at step 312. The appearance of the win-boost (GRAND) symbol 238 in row 220 is detected at step 320. The maximum win-boost amount of 1199 is assigned to the win-boost symbol at step 322.
Since there was no initial total award, the final award is the 1199 credits assigned to the win-boost symbol at step 322, which is then paid at step 324.

Many jurisdictions prevent any single wins over X dollars or Y times the amount of dollars wagered. Often the size of the wager is limited as well. In certain non-limiting exemplary embodiments, if any single win or combination of wins is over the jurisdictional payout limit then the maximum allowed by law will be given to the player and the remaining overpay amount may be thrown out at the player expense, accrued to a personal progressive, accrued to a site wide progressive prize pool, given back to the player, or become “cashable” over other games that are paid for and that do not go over the jurisdictional limit. The overpay amount may accrue to a reflexive game engine that then retunes the game to ensure non-paid wins are given out over time. The overpay amount may be paid to the player over a number of games with higher expected value due tobetter game math, better pay tables, higher payout percentage games, more bonus rounds, free games, extra bonus symbols, more winning combinations for future games, more spins for a single game, longer bonus rounds, etc. These overpay techniques ensure that payout-limitation laws are complied with while still letting players know that the overpay amounts will be paid out if players keep playing long enough with new wagers. Onscreen indication of the overpay amount that has yet to be paid to the player may be shown to the player or hidden from the player's view. Normally once the overpay has been given back to the player or players then each associated EGM will reset to its normal game state.

According to some aspects of the present disclosure, the win-boost amount is a maximum award that can be awarded for any single outcome of the wagering game. As one non-limiting example, the maximum award associated with a win-boost symbol can be the maximum award that is legally permitted for a single play of the wagering game in a particular jurisdiction (e.g., at present, the State of Illinois legally limits the maximum payout to $1199 for a single play of the wagering game). The game is designed to limit all possible combinations of pay table awards to less than the maximum legal payout using methods known to those skilled in the art. Nonlimiting examples include smaller pay table award amounts, reel-strip layouts and symbol weights to limit the frequency of certain higher paying win combinations and the use of “blocking” symbols to break up the possibility of higher-paying win combinations. For example, a value-bearing symbol with a small award amount might heavily populate the reel strips of a central reel, effectively substituting a smaller pay award for what might have been a larger pay award such as a five of a kind. Limiting the size of smaller awards and employing a win-boost symbol to increase the initial total award to the maximum award permitted in the jurisdiction to prevent overpay situations has the advantage of being significantly more efficient than the above-mentioned overpay compensation techniques from the standpoints of game-rule complexity, software complexity, and in reducing processing-power requirements, data-storage requirements, and network-bandwidth requirements. Furthermore, the use of an “instant” win-boost amount provides the player with immediate, rather than deferred, satisfaction.

FIGS. 8A and 8B, in accordance with one or more embodiments, illustrate another significant advantage to the use of one or more win-boost amounts in jurisdictions in which single wins are capped. FIG. 8A advertises a set of bonus (GRAND, MAJOR, MINOR, MINI) awards in a typical capped game of the prior art. As an example, in a jurisdiction that limits a single win to a maximum of $1199, the GRAND prize meter 810 in FIG. 8A is set to a fixed award amount of $500. This is because winning the GRAND prize may be combined with other base game wins. The sum of both the GRAND prize and the smaller base game wins cannot exceed $1199 without some form of overpay handling, which is preferably avoided. In contrast, in the example of FIG. 8B, which illustrates a win-boost game, according to an embodiment of the present invention. As shown in FIG. 8B, the GRAND prize meter 820 advertises a win-boost maximum of $1199, and can be used in the same jurisdiction as the 8A. While the maximum win available in both games is the same, the potential for a big win is more clearly stated in the win-boost game of FIG. 8B and more likely to be attractive to a player.

In this description, numerous specific details are set forth. However, it is understood that embodiments of the invention may be practiced without these specific details or with additional details or in various combinations. As another non-limiting example, the win-boost amount can be set to an award less than the maximum payout but greater than the average standard pay-per-outcome of the wagering game. However more generally, the win-boost amount can be any amount. In some embodiments, the average standard pay-per-outcome may exceed the win-boost amount. In these cases, the win-boost symbol may appear frequently as consolation prize for a an otherwise zero or low-outcome game outcome. It should be understood that the quantity of win-boost symbols and maximum win-boost awards described are intended as examples and other quantities of win-boost symbols and maximum awards can be employed. In the examples illustrated in FIGS. 6-7, the wagering game outcomes include a single boost-award symbol associated with a win-boost amount. According to additional and/or alternative aspects of the present disclosure, the wagering game can include a plurality of win-boost awards, each associated with respective win-boost maximum(s). For example, in the examples of FIGS. 4-7, the GRAND meter 266 and the MEGA meter 268 each indicates a maximum win-boost amount associated with the appearance of those win-boost symbols in the array. The MINOR meter 262 and the MINI meter 264 are, in contrast, set to fixed values to be awarded in combination with normal pay table pays upon the appearance of the MINOR or MINI symbols in the array.

According to some aspects of the present disclosure, the win-boost award functionality can be employed for every play of the wagering game without any determination as to whether a player is eligible to receive a win-boost award. According to alternative aspects of the present disclosure, a win-boost award can be provided only if the player is determined to be eligible (e.g., via the CPU 42 and/or the external systems 60) to receive the win-boost award. For example, player eligibility to receive the win-boost award for a play of the wagering game can be based on an amount wagered by the player for the play. In one non-limiting implementation, the player is eligible to receive a win-boost award only if the player wagered a max bet for the play of the wagering game. As another example, player eligibility to receive the win-boost award can be based on a player's turnover amount over a plurality of plays of the wagering game. As yet another example, player eligibility to receive the win-boost award can be based on a player's status in a loyalty program with an operator of the wagering game.

It is contemplated that, according to some aspects, the win-boost award can be employed in a basic wagering game, a bonus wagering game, and/or combinations thereof. FIG. 3, described by way of example above, represent an exemplary algorithm that corresponds to at least some instructions executed by the CPU 42 in FIG. 2 to perform the above-described functions associated with the disclosed concepts. It is also within the scope and spirit of the present concepts to omit steps, include additional steps, and/or modify the order of steps presented above. For example, steps for determination of player eligibility for a win-boost award might be added between steps 314 and 316 and step 312 and 320. In another example, the initial total award may be paid prior to determination of the win-boost amount at step at 318 such that the final award at step 324 is equivalent only to the win-boost amount (i.e., the determined difference between the initial total award and the maximum award associated with the win-boost symbol).

In some embodiments, the wagering game includes win-boost amounts that remain constant for every wagering-game play, regardless of a player's wager. In other embodiments, the wagering game may include amounts that vary, linearly or otherwise, based on a player's wager. For example, in a linear-variance embodiment, the win-boost maximum may be set at 200 credits for a player wagering a single credit per play, whereas the win-boost maximum may be set at 400 credits for a player wagering two credits per play. In a nonlinear-variance embodiment, the win-boost amount may be set at 200 credits for a player wagering a single credit per play, whereas the win-boost amount may be set at 250 credits for a player wagering two credits per play. Thus, in this nonlinear example, a payback advantage can be provided to players placing higher wagers per game. It should be noted that the above embodiments are for illustration, and various other types of linear and nonlinear threshold-variance mechanics may be utilized and understood by those skilled in the art. The present invention provides skilled artisans nearly endless mathematical flexibility in designing wagering games implementing override awards.

While in the embodiments described above, the wagering game included a slot-type wagering game, it should be understood that the wagering game can additionally or alternatively include other wagering games, such as video poker, video blackjack, video lottery, etc., in whole or part. Additionally, for purposes of the present detailed description, the terms “wagering games,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game may involve wagers of real money, as found with typical land-based or on-line casino games. In other embodiments, the wagering game may additionally, or alternatively, involve wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

In other instances, well-known circuits, structures, and techniques have not been shown in detail in order not to obscure the understanding of this description. Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein. Each claim, as may be amended, constitutes an embodiment of the invention, incorporated by reference into the detailed description. Moreover, in this description, the phrase “exemplary embodiment” means that the embodiment being referred to serves as an example or illustration.

Block diagrams illustrate exemplary embodiments of the invention. Flow diagrams illustrate operations of the exemplary embodiments of the invention. The operations of the flow diagrams are described with reference to the example embodiments shown in the block diagrams. However, it should be understood that the operations of the flow diagrams could be performed by embodiments of the invention other than those discussed with reference to the block diagrams, and embodiments discussed with references to the block diagrams could perform operations different than those discussed with reference to the flow diagrams. Additionally, some embodiments may not perform all the operations shown in a flow diagram. Moreover, it should be understood that although the flow diagrams depict serial operations, certain embodiments could perform certain of those operations in parallel or in a different sequence.

Each of these embodiments and obvious variations thereof is contemplated as falling within the spirit and scope of the claimed invention, which is set forth in the following claims. Moreover, the present concepts expressly include any and all combinations and subcombinations of the preceding elements and aspects.

1. A method in a gaming system having game-logic circuitry including one or more central processing units and one or more memory devices, the method comprising:
receiving, via one or more input devices, an input indicative of a wager;
displaying, via one or more display devices, a plurality of symbols to indicate a randomly selected outcome of a wagering game in a display area;
determining, via the game-logic circuitry, one or more award amounts for the randomly selected outcome, the one or more award amounts being based on the wager and the symbols of the randomly selected outcome;
determining, via at the game-logic circuitry, an initial total award based on the one or more award amounts;
in response to the plurality of symbols including at least one win-boost symbol, comparing, via the game-logic circuitry, the initial total award to a predetermined maximum award associated with the at least one win-boost symbol, determining the difference between the maximum award and the initial total award, assigning the difference to the win-boost symbol, and summing the initial total award and the difference to create a final award;
awarding the final award; and
receiving, via at least one of one or more electronic input devices, a cash out input that initiates a payout from the credit balance via a value output device.

2. The method of claim 1, wherein the predetermined maximum award is a maximum award for the wagering game.

3. The method of claim 2, wherein the at least one win-boost symbol comprises N win-boost symbols, the maximum award associated with the Nth win-boost symbol being a maximum award for the wagering game.

4. The method of claim 1, further comprising determining player eligibility to receive the win-boost symbol

5. The method of claim 4, wherein the player eligibility is determined based on whether the wager is a max bet.

6. The method of claim 4, wherein the player eligibility is determined based on a turnover amount over a plurality of plays of the wagering game.

7. The method of claim 1, wherein a sum of the one or more award amounts does not exceed a maximum award for the wagering game.

8. The method of claim 1, wherein the maximum award is a predetermined maximum value for the gaming system.

9. The method of claim 1, wherein the maximum award is a predetermined value based on the wager input's value.

10. A gaming system comprising:
one or more input devices;
one or more display devices;
game-logic circuitry, comprising one or more central processing units and one or more memory devices, the one or more memory devices storing instructions that, when executed by the one or more central processing units, cause the game-logic circuitry to:
receive, via at least one of the one or more input devices, an input indicative of a wager;
display, via at least one of the one or more display devices, a randomly selected outcome of a wagering game;
evaluate the randomly selected outcome to determine one or more award amounts;
determine, via at the game-logic circuitry, an initial total award based on the one or more award amounts;
in response to the plurality of symbols including at least one win-boost symbol, comparing, via the game-logic circuitry, the initial total award to a predetermined maximum award associated with the at least one win-boost symbol, determine the difference between the maximum award and the initial total award, assigning the difference to the win-boost symbol and summing the initial total award and the difference to create a final award;
award the final award; and
receive, via at least one of one or more electronic input devices, a cash out input that initiates a payout from the credit balance via a value output device.

11. The system of claim 10, wherein the predetermined maximum award is a maximum award for the wagering game.

12. The system of claim 10, wherein the at least one win-boost symbol comprises N win-boost symbols, the maximum award associated with the Nth win-boost symbol being a maximum award for the wagering game.

13. The system of claim 10, further comprising determining player eligibility to receive the win-boost symbol.

14. The system of claim 13, wherein the player eligibility is determined based on whether the wager is a max bet.

15. The system of claim 13, wherein the player eligibility is determined based on a turnover amount over a plurality of plays of the wagering game.

16. The system of claim 13, wherein a sum of the one or more award amounts does not exceed a maximum award for the wagering game.

17. A gaming machine comprising:
one or more input devices;
one or more display devices;
game-logic circuitry, comprising one or more central processing units and one or more memory devices, the one or more memory devices storing instructions that, when executed by the one or more central processing units, cause the game-logic circuitry to:
receive, via at least one of the one or more input devices, an input indicative of a wager;
display, via at least one of the one or more display devices, a randomly selected outcome of a wagering game;
evaluate the randomly selected outcome to determine one or more award amounts;
determine, via at the game-logic circuitry, an initial total award based on the one or more award amounts;
in response to the plurality of symbols including at least one win-boost symbol, comparing, via the game-logic circuitry, the initial total award to a predetermined maximum award associated with the at least one win-boost symbol, determine the difference between the maximum award and the initial total award, assigning the difference to the win-boost symbol and summing the initial total award and the difference to create a final award;
award the final award; and
receive, via at least one of one or more electronic input devices, a cash out input that initiates a payout from the credit balance via a value output device.

18. The gaming machine of claim 17, wherein the at least one win-boost symbol comprises N win-boost symbols, the maximum award associated with the Nth win-boost symbol being a maximum award for the wagering game.

19. The gaming machine of claim 17, wherein the maximum award is a predetermined maximum value for the gaming machine.

20. The method of claim 1, wherein the maximum award is a predetermined value based on the wager input's value.
